(19) United States
(12) Patent Application Publication
(10) Pub. No.: US 2026/0172793 A1
(43) Pub. Date: Jun. 18, 2026

(54) COEXISTENCE BETWEEN DIFFERENT AUTOMOTIVE RADIO ACCESS TECHNOLOGIES

(71) Applicant: QUALCOMM Incorporated, San Diego, CA (US)

(72) Inventors: Prashanth AKULA, San Diego, CA (US); Sivaramakrishna VEEREPALLI, San Diego, CA (US); Tien Viet NGUYEN, Bridgewater, NJ (US); Cheol Hee PARK, San Diego, CA (US); Soumya DAS, San Diego, CA (US); Udeerna DOPPALAPUDI, Poway, CA (US); Ming YE, San Diego, CA (US); Chuang YANG, Shanghai (CN); Gajinder Singh VIJ, San Diego, CA (US); Rakesh JALOTA, Hyderabad (IN)

(21) Appl. No.: 19/125,363

(22) PCT Filed: Dec. 12, 2022
(86) PCT No.: PCT/CN2022/138278

§ 371 Date: Apr. 29, 2025

(51) Int. Cl. H04W 4/40; H04B 1/44; H04W 56/00; H04W 88/06

(52) U.S. Cl. CPC H04W 4/40; H04B 1/44; H04W 56/001; H04W 88/06

(57) ABSTRACT

Various aspects of the present disclosure generally relate to managing wireless communication in a vehicular communication system. In some aspects, a coexistence manager may receive, from a first component associated with a first automotive radio access technology (RAT), an interrupt signal to indicate first timing information associated with an upcoming transmission by the first component associated with the first automotive RAT. The coexistence manager may monitor second timing information associated with a transmission by the second component associated with the second automotive RAT. The coexistence manager may perform an action to manage coexistence between the upcoming transmission by the first component and the transmission by the second component in accordance with the first timing information associated with the upcoming transmission by the first component and the second timing information associated with the transmission by the second component. Numerous other aspects are described.

### FIELD OF THE DISCLOSURE

Aspects of the present disclosure generally relate to wireless communication and to techniques and apparatuses associated with coexistence between different automotive radio access technologies (RATs).

### BACKGROUND

Vehicle-to-everything (V2X) communication is an umbrella term that generally refers to technologies that can be used to communicate information between a vehicle equipped with suitable communication capabilities and one or more other devices. For example, V2X communication may include vehicle-to-vehicle (V2V) communication technologies that allow vehicles to communicate with one another (e.g., to support safety systems with non-line-of-sight and latency-sensitive collision avoidance capabilities), vehicle-to-infrastructure (V2I) communication technologies that allow vehicles to communicate with external systems such as street lights and/or buildings, vehicle-to-pedestrian (V2P) communication technologies that allow vehicles to communicate with smartphones and/or connected wearable devices, and/or vehicle-to-network (V2N) communication technologies that allow vehicles to communicate with network devices. In general, V2X communication may be supported using one or more automotive RATs as an enabling technology.

In some cases, however, challenges may arise when different automotive RATs are deployed on different channels in an intelligent transport system (ITS) band. For example, dedicated short range communications (DSRC) is an automotive RAT that is generally based on Institute of Electrical and Electronics Engineers (IEEE) 802.11p, which is an approved amendment to the IEEE 802.11 standard (e.g., DSRC is a Wi-Fi solution to support V2X communications, including data exchange between high-speed vehicles, or V2V communication, and between vehicles and roadside infrastructure, or V2I communication). On the other hand, cellular V2X (C-V2X) is an automotive RAT based on 3GPP standards, using mobile cellular connectivity based on an LTE RAT or an NR RAT to exchange messages between vehicles, pedestrians, wayside traffic control devices such as traffic signals, and wireless network infrastructure. In some areas (e.g., Europe and Japan), there are a significant number of vehicles that are already deployed with support for DSRC. However, because DSRC has not gained widespread adoption (e.g., due in part to the high cost and lack of interoperability with existing cellular networks), C-V2X has emerged as a more promising automotive RAT for enabling V2X applications worldwide.

Nonetheless, because many vehicles have already been deployed with support for DSRC, a V2X communication system (e.g., a V2X transceiver) may need to support different automotive RATs concurrently for both transmission and reception (e.g., a V2X communication system on a new vehicle may support DSRC to communicate with older vehicles that only support DSRC and may support C-V2X to communicate with newer vehicles, pedestrian devices, RSUs, and/or network infrastructure that are based on C-V2X standards). However, enabling concurrent support for DSRC and C-V2X poses various challenges. For example, a V2X communication system typically includes two antennas that are shared for transmission and reception using different automotive RATs, such as DSRC and C-V2X. This may be due, for example, to the high cost of cabling on the vehicular platform and/or to poor isolation between the antennas. In some cases, the half-duplex nature of V2X technology may be due to the restriction of the shared antennas for transmission and reception in V2X. For example, once there is a transmission using any of the automotive RATs from any one of the antennas, there may be no reception for any of the automotive RATs on all of the antennas. Furthermore, only one automotive RAT may be active at any given time (e.g., the two antennas are both used for DSRC or both used for C-V2X at any given time), and the different automotive RATs may be associated with slot structures that are not time aligned. Accordingly, there could be Tx-Tx collisions and/or Rx-Tx collisions between DSRC and C-V2X, which may degrade V2X performance and/or cause safety issues due to a collision resulting in a failure to receive or transmit a V2X message. Furthermore, different automobiles within proximity of one another may also support different automotive RATs (e.g., a car supporting DSRC communications drives in the lane next to another car supporting C-V2X communications), which results in further Tx-Tx collisions and/or Rx-Tx collisions between these different automobiles'communications systems.

### SUMMARY

Some aspects described herein relate to a coexistence manager for managing wireless communication in a vehicular communication system. The coexistence manager may include a memory and one or more processors coupled to the memory. The one or more processors may be configured to receive, from a first component associated with a first automotive radio access technology (RAT), an interrupt signal transmitted to a second component associated with a second automotive RAT to indicate first timing information associated with an upcoming transmission by the first component associated with the first automotive RAT. The one or more processors may be configured to monitor second timing information associated with a transmission by the second component associated with the second automotive RAT. The one or more processors may be configured to perform an action to manage coexistence between the upcoming transmission by the first component associated with the first automotive RAT and the transmission by the second component associated with the second automotive RAT in accordance with the first timing information associated with the upcoming transmission by the first component associated with the first automotive RAT and the second timing information associated with the transmission by the second component associated with the second automotive RAT.

Some aspects described herein relate to a coexistence manager for managing wireless communication in a vehicular communication system. The coexistence manager may include a memory and one or more processors coupled to the memory. The one or more processors may be configured to monitor a first transmit power level on a first transmit path associated with a first component associated with a first automotive RAT. The one or more processors may be configured to monitor a second transmit power level on a second transmit path associated with a second component associated with a second automotive RAT. The one or more processors may be configured to control power leakage on a hardware leakage path from the first transmit path associated with the first component to a receive path associated with the second component in accordance with the first transmit power level on the first transmit path and the second transmit power level on the second transmit path.

Some aspects described herein relate to a method of managing wireless communication in a vehicular communication system performed by a user equipment (UE). The method may include receiving, from a first component associated with a first automotive RAT, an interrupt signal transmitted to a second component associated with a second automotive RAT to indicate first timing information associated with an upcoming transmission by the first component associated with the first automotive RAT. The method may include monitoring second timing information associated with a transmission by the second component associated with the second automotive RAT. The method may include performing an action to manage coexistence between the upcoming transmission by the first component associated with the first automotive RAT and the transmission by the second component associated with the second automotive RAT in accordance with the first timing information associated with the upcoming transmission by the first component associated with the first automotive RAT and the second timing information associated with the transmission by the second component associated with the second automotive RAT.

Some aspects described herein relate to a method of managing wireless communication in a vehicular communication system performed by a UE. The method may include monitoring a first transmit power level on a first transmit path associated with a first component associated with a first automotive RAT. The method may include monitoring a second transmit power level on a second transmit path associated with a second component associated with a second automotive RAT. The method may include controlling power leakage on a hardware leakage path from the first transmit path associated with the first component to a receive path associated with the second component in accordance with the first transmit power level on the first transmit path and the second transmit power level on the second transmit path.

Some aspects described herein relate to a non-transitory computer-readable medium that stores a set of instructions for managing wireless communication in a vehicular communication system by a coexistence manager. The set of instructions, when executed by one or more processors of the coexistence manager, may cause the coexistence manager to receive, from a first component associated with a first automotive RAT, an interrupt signal transmitted to a second component associated with a second automotive RAT to indicate first timing information associated with an upcoming transmission by the first component associated with the first automotive RAT. The set of instructions, when executed by one or more processors of the coexistence manager, may cause the coexistence manager to monitor second timing information associated with a transmission by the second component associated with the second automotive RAT. The set of instructions, when executed by one or more processors of the coexistence manager, may cause the coexistence manager to perform an action to manage coexistence between the upcoming transmission by the first component associated with the first automotive RAT and the transmission by the second component associated with the second automotive RAT in accordance with the first timing information associated with the upcoming transmission by the first component associated with the first automotive RAT and the second timing information associated with the transmission by the second component associated with the second automotive RAT.

Some aspects described herein relate to a non-transitory computer-readable medium that stores a set of instructions for managing wireless communication in a vehicular communication system by a coexistence manager. The set of instructions, when executed by one or more processors of the coexistence manager, may cause the coexistence manager to monitor a first transmit power level on a first transmit path associated with a first component associated with a first automotive RAT. The set of instructions, when executed by one or more processors of the coexistence manager, may cause the coexistence manager to monitor a second transmit power level on a second transmit path associated with a second component associated with a second automotive RAT. The set of instructions, when executed by one or more processors of the coexistence manager, may cause the coexistence manager to control power leakage on a hardware leakage path from the first transmit path associated with the first component to a receive path associated with the second component in accordance with the first transmit power level on the first transmit path and the second transmit power level on the second transmit path.

Some aspects described herein relate to an apparatus for managing wireless communication in a vehicular communication system. The apparatus may include means for receiving, from a first component associated with a first automotive RAT, an interrupt signal transmitted to a second component associated with a second automotive RAT to indicate first timing information associated with an upcoming transmission by the first component associated with the first automotive RAT. The apparatus may include means for monitoring second timing information associated with a transmission by the second component associated with the second automotive RAT. The apparatus may include means for performing an action to manage coexistence between the upcoming transmission by the first component associated with the first automotive RAT and the transmission by the second component associated with the second automotive RAT in accordance with the first timing information associated with the upcoming transmission by the first component associated with the first automotive RAT and the second timing information associated with the transmission by the second component associated with the second automotive RAT.

Some aspects described herein relate to an apparatus for managing wireless communication in a vehicular communication system. The apparatus may include means for monitoring a first transmit power level on a first transmit path associated with a first component associated with a first automotive RAT. The apparatus may include means for monitoring a second transmit power level on a second transmit path associated with a second component associated with a second automotive RAT. The apparatus may include means for controlling power leakage on a hardware leakage path from the first transmit path associated with the first component to a receive path associated with the second component in accordance with the first transmit power level on the first transmit path and the second transmit power level on the second transmit path.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network supporting different radio access technologies (RATs).

FIG. 2 is a diagram illustrating an example of at least two user equipments (UEs) communicating using sidelink communications and vehicle-to-everything (V2X) communications.

FIG. 3 is a diagram illustrating an example of sidelink communications and access link communications.

FIGS. 4A-4D are diagrams illustrating examples associated with coexistence between different automotive radio access technologies (RATs. FIG. 4A illustrates an example communication system that may be used in a vehicular UE to enable concurrent support for dedicated short-range communication (DSRC) and cellular V2X (C-V2X) communication using interrupt-based techniques to transfer timing information to intelligently coordinate coexistence between DSRC and C-V2X components. FIG. 4B and FIG. 4C illustrate various scenarios in which a coexistence manager resolves potential collisions between a DSRC transmission and a C-V2X transmission. FIG. 4D illustrates an example communication system that may be used in a vehicular UE to enable concurrent support for DSRC and C-V2X by controlling power leakage on hardware leakage paths associated with different RATs.

FIGS. 5-6 are diagrams illustrating example processes associated with coexistence between different automotive RATs.

FIG. 7 is a diagram of an example apparatus for managing coexistence between different automotive RATs.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, a RAT subsequent to 5G (e.g., 6G), and/or a dedicated short-range communications (DSRC) RAT, among other examples.

Various aspects described herein relate generally to a coexistence manager that can manage coexistence in a vehicular communication system that supports different automotive radio access technologies (RATs). For example, some aspects described herein more specifically relate to an interrupt-based technique that may be implemented in the coexistence manager to resolve transmit-transmit collisions, transmit-receive collisions, and/or other collisions that may potentially occur when a first automotive RAT, such as dedicated short-range communications (DSRC), and a second automotive RAT, such as cellular vehicle-to-everything (C-V2X), share one or more antennas but only one automotive RAT can be active at a given time. For example, in some aspects, the coexistence manager may use an interrupt-based technique to transfer timing information between one or more DSRC components and one or more C-V2X components to intelligently coordinate coexistence between the DSRC and C-V2X components. For example, in the interrupt-based technique, the C-V2X component may assert an interrupt to indicate timing information associated with an upcoming C-V2X transmission, and the coexistence manager may send control signals to the DSRC and/or C-V2X components as-needed to avoid or resolve potential collisions between the upcoming C-V2X transmission and a DSRC transmission. For example, in cases where a DSRC transmission is ongoing when the interrupt from the C-V2X component is asserted, the coexistence manager may allow the ongoing DSRC transmission to continue if the ongoing DSRC transmission can finish before the upcoming C-V2X transmission begins, send a control signal to drop (e.g., suppress) a portion of the ongoing DSRC transmission that overlaps with the upcoming C-V2X transmission, and/or send a control signal to blank (e.g., suppress) a portion of the upcoming C-V2X transmission that overlaps with the ongoing DSRC transmission. Additionally, or alternatively, in cases where the DSRC component(s) assert an interrupt to start a DSRC transmission after the interrupt has been received from the C-V2X component(s), the coexistence manager may delay the DSRC transmission until after the C-V2X transmission has completed or may start the DSRC transmission and suppress a portion of the C-V2X transmission that overlaps with the DSRC transmission. Additionally, or alternatively, the coexistence manager may use a power leakage technique to avoid or resolve potential collisions between a C-V2X transmission and a DSRC transmission. For example, the vehicular communication system may include a hardware leakage path from a C-V2X transmit path to a DSRC receive path, and the coexistence manager may be configured to allow transmit power to leak from the C-V2X transmit path into the DSRC receive path when a C-V2X transmission is ongoing, which may force the DSRC component(s) to detect a channel busy state and therefore delay a DSRC transmission until the C-V2X transmission is complete. Furthermore, because a transmit power used in the C-V2X transmit path may vary, the coexistence manager may dynamically adjust an attenuation level on the hardware leakage path to ensure that the power leaked into the DSRC receive path is sufficient to result in the DSRC component(s) detecting a channel busy state that causes the DSRC transmission to be delayed.

Particular aspects of the subject matter described in this disclosure can be implemented to realize one or more of the following potential advantages. In some examples, the described techniques can be used to intelligently resolve transmit-transmit, transmit-receive, and/or other suitable collisions in a vehicular communication system supporting different automotive RATs that share one or more antennas. For example, by using timing information associated with ongoing and/or upcoming transmissions associated with the respective automotive RATs, the coexistence manager can ensure that only one automotive RAT is active at a given time and minimize a duration that a transmission associated with one automotive RAT is suppressed or delayed. Furthermore, by supporting techniques in which a transmission associated with one automotive RAT is delayed or requeued until after a potentially conflicting transmission is complete, the coexistence manager may resolve the potential collisions without losing packets to be transmitted using the delayed or requeued automotive RAT. In addition, by configuring a delay duration based on the priority or importance of packet contents to be transmitted, the coexistence manager can ensure that critical safety messages or other high-priority messages are transmitted when needed. Furthermore, in cases where the coexistence manager uses the power leakage technique to delay a transmission associated with a particular automotive RAT, adjusting the attenuation level on the hardware leakage path may ensure that components associated with the automotive RAT will detect a channel busy state and therefore delay any transmission that may be started while there is an ongoing transmission associated with another automotive RAT. In this way, as described herein, the coexistence manager may use one or more techniques to intelligently coordinate coexistence between different automotive RATs in a vehicular communication system.

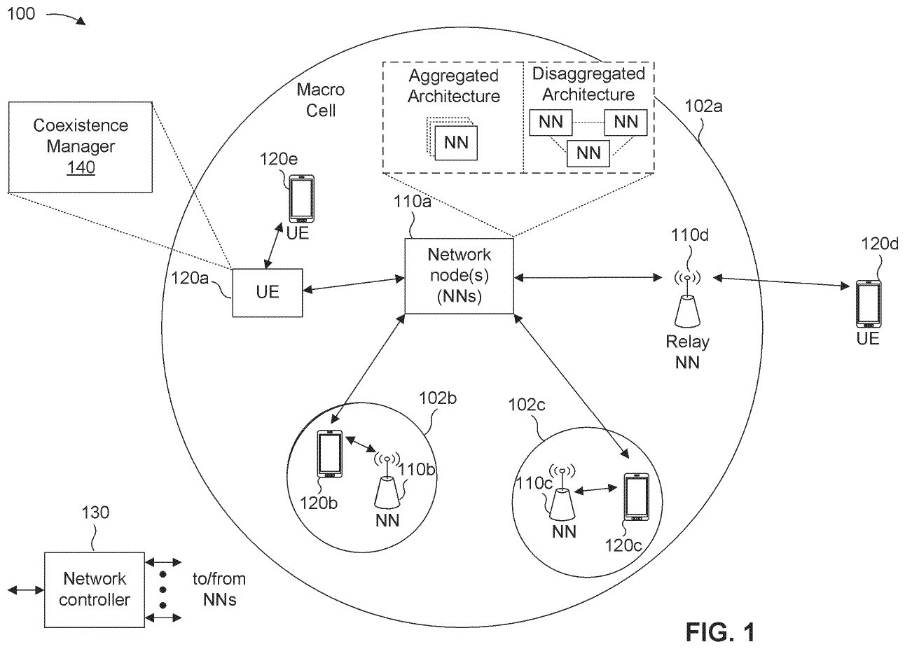

FIG. 1 is a diagram illustrating an example of a wireless network 100 supporting different RATs. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed. In some cases, DSRC RAT networks may be deployed in addition to NR or 5G RAT networks.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a coexistence manager 140. In some aspects, the coexistence manager 140 may be included in a vehicular communication system of the UE 120, and may be used to intelligently control coexistence between different automotive RATs that are supported in the vehicular communication system. For example, in some aspects, the coexistence manager may use one or more techniques described in further detail herein to ensure that only one automotive RAT is active at a given time, and to resolve transmit-transmit, transmit-receive, and/or other potential collisions between different automotive RATs that share one or more antennas.

For example, as described in more detail elsewhere herein, the coexistence manager 140 may receive, from a first component associated with a first automotive RAT, an interrupt signal transmitted to a second component associated with a second automotive RAT to indicate first timing information associated with an upcoming transmission by the first component associated with the first automotive RAT; monitor second timing information associated with a transmission by the second component associated with the second automotive RAT; and perform an action to manage coexistence between the upcoming transmission by the first component associated with the first automotive RAT and the transmission by the second component associated with the second automotive RAT in accordance with the first timing information associated with the upcoming transmission by the first component associated with the first automotive RAT and the second timing information associated with the transmission by the second component associated with the second automotive RAT.

Additionally, or alternatively, in some aspects, the coexistence manager 140 may monitor a first transmit power level on a first transmit path associated with a first component associated with a first automotive RAT; monitor a second transmit power level on a second transmit path associated with a second component associated with a second automotive RAT; and control power leakage on a hardware leakage path from the first transmit path associated with the first component to a receive path associated with the second component in accordance with the first transmit power level on the first transmit path and the second transmit power level on the second transmit path. Additionally, or alternatively, the coexistence manager 140 may perform one or more other operations described herein.

In one example, the UE 120a may correspond to a C-V2X-enabled vehicular communication system (e.g., based on an LTE RAT and/or an NR RAT) on a first vehicle or automobile, and the UE 120e may correspond to a DSRC-enabled vehicular communication system that may be included on the first vehicle or automobile or a second vehicle or automobile that is different from the first vehicle or automobile. In some aspects, the coexistence manager 140 may be located entirely on one or more components that support C-V2X communication, located entirely on one or more components that support DSRC, partially located on the one or more components that support C-V2X communication and partially located on the one or more components that support DSRC, or located on a separate chip or a separate device (e.g., on a network node 110). Furthermore, in cases where the UE 120a is communicating while traveling on one or more roadways, the coexistence manager 140 may generally operate across N vehicles or automobiles in a distributed manner, where N is an integer having a value greater than or equal to two.

As indicated above, FIG. 1 is provided as an example. Other examples may differ from what is described with regard to FIG. 1.

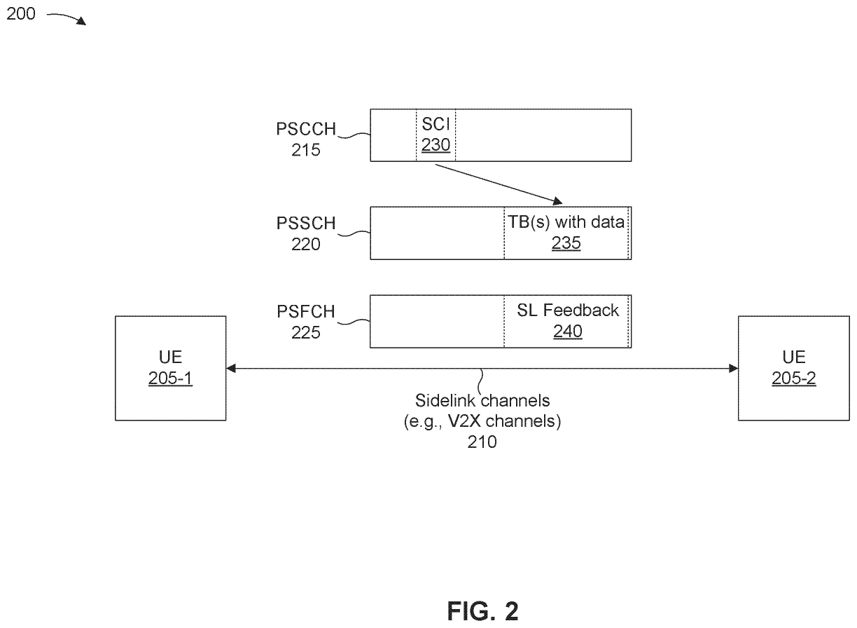

FIG. 2 is a diagram illustrating an example 200 of at least two UEs communicating using sidelink communications and V2X communications.

As shown in FIG. 2, a first UE 205-1 may communicate with a second UE 205-2 (and one or more other UEs 205) via one or more sidelink channels 210. The UEs 205-1 and 205-2 may communicate using the one or more sidelink channels 210 for P2P communications, D2D communications, V2X communications (e.g., which may include V2V communications, V2I communications, and/or V2P communications) and/or mesh networking. In one example, the first UE 205-1 may be a first V2X device (e.g., a first vehicle, roadside unit (RSU), pedestrian device, or network node) and the second UE 205-2 may be a second V2X device (e.g., a second vehicle, RSU, pedestrian device, or network node). The first V2X device and the second V2X device may communicate using cellular V2X (C-V2X) communications (e.g., V2X communications that use 3GPP standardized LTE, NR, or other mobile cellular connectivity to exchange messages between vehicles, pedestrians, wayside traffic control devices, and/or other suitable V2X devices). In some aspects, the one or more sidelink channels 210 may use a PC5 interface and/or may operate in a high frequency band (e.g., the 5.9 GHz band). Additionally, or alternatively, the UEs 205 may synchronize timing of transmission time intervals (TTIs) (e.g., frames, subframes, slots, or symbols) using global navigation satellite system (GNSS) timing.

As further shown in FIG. 2, the one or more sidelink channels 210 may include a physical sidelink control channel (PSCCH) 215, a physical sidelink shared channel (PSSCH) 220, and/or a physical sidelink feedback channel (PSFCH) 225. The PSCCH 215 may be used to communicate control information, similar to a physical downlink control channel (PDCCH) and/or a physical uplink control channel (PUCCH) used for cellular communications with a network node 110 via an access link or an access channel. The PSSCH 220 may be used to communicate data, similar to a physical downlink shared channel (PDSCH) and/or a physical uplink shared channel (PUSCH) used for cellular communications with a network node 110 via an access link or an access channel. For example, the PSCCH 215 may carry sidelink control information (SCI) 230, which may indicate various control information used for sidelink communications, such as one or more resources (e.g., time resources, frequency resources, and/or spatial resources) where a transport block (TB) 235 may be carried on the PSSCH 220. The TB 235 may include data. The PSFCH 225 may be used to communicate sidelink feedback 240, such as hybrid automatic repeat request (HARQ) feedback (e.g., acknowledgement or negative acknowledgement (ACK/NACK) information), transmit power control (TPC), and/or a scheduling request (SR).

In some aspects, a UE 205 may operate using a sidelink transmission mode (e.g., mode 1) where resource selection and/or scheduling is performed by a network node 110 (e.g., a base station, a CU, or a DU). For example, the UE 205 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 205 may operate using a transmission mode (e.g., mode 2) where resource selection and/or scheduling is performed by the UE 205 (e.g., rather than a network node 110). In some aspects, the UE 205 may perform resource selection and/or scheduling by sensing channel availability for transmissions. For example, the UE 205 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 205 may perform resource selection and/or scheduling using SCI 230 received in the PSCCH 215, which may indicate occupied resources and/or channel parameters. Additionally, or alternatively, the UE 205 may perform resource selection and/or scheduling by determining a channel busy ratio (CBR) associated with various sidelink channels, which may be used for rate control (e.g., by indicating a maximum number of resource blocks that the UE 205 can use for a particular set of subframes).

In the transmission mode where resource selection and/or scheduling is performed by a UE 205, the UE 205 may generate sidelink grants, and may transmit the grants in SCI 230. A sidelink grant may indicate, for example, one or more parameters (e.g., transmission parameters) to be used for an upcoming sidelink transmission, such as one or more resource blocks to be used for the upcoming sidelink transmission on the PSSCH 220 (e.g., for TBs 235), one or more subframes to be used for the upcoming sidelink transmission, and/or an MCS to be used for the upcoming sidelink transmission. In some aspects, a UE 205 may generate a sidelink grant that indicates one or more parameters for semi-persistent scheduling (SPS), such as a periodicity of a sidelink transmission. Additionally, or alternatively, the UE 205 may generate a sidelink grant for event-driven scheduling, such as for an on-demand sidelink message.

As indicated above, FIG. 2 is provided as an example. Other examples may differ from what is described with regard to FIG. 2.

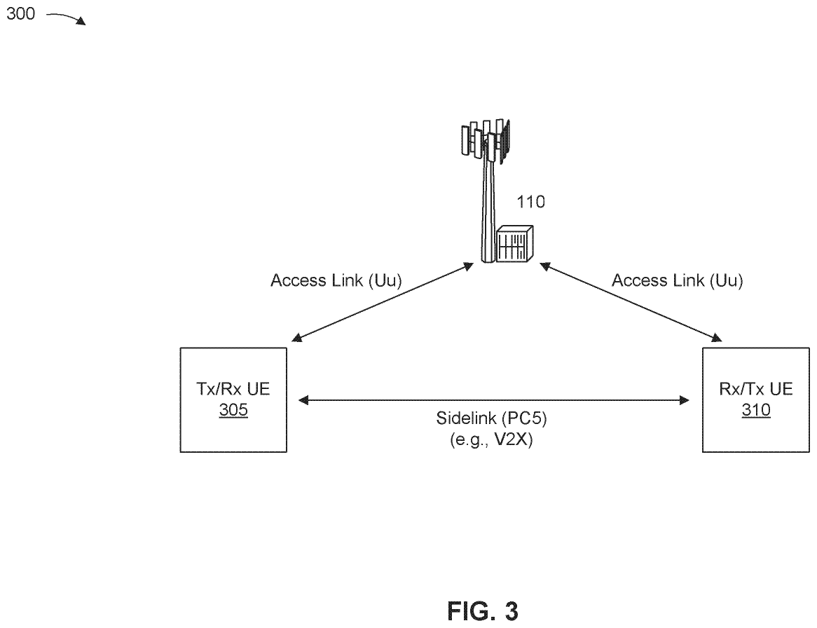

FIG. 3 is a diagram illustrating an example 300 of sidelink communications and access link communications, in accordance with the present disclosure.

As shown in FIG. 3, a transmitter (Tx)/receiver (Rx) UE 305 and an Rx/Tx UE 310 may communicate with one another via a sidelink, as described above in connection with FIG. 2. In some cases, the Tx/Rx UE 305 may be a first V2X device (such as the first V2X device 205-1) and the Tx/Rx UE 310 may be a second V2X device (such as the second V2X device 205-2). As further shown, in some sidelink modes, a network node 110 may communicate with the Tx/Rx UE 305 (e.g., directly or via one or more network nodes), such as via a first access link. Additionally, or alternatively, in some sidelink modes, the network node 110 may communicate with the Rx/Tx UE 310 (e.g., directly or via one or more network nodes), such as via a first access link. The Tx/Rx UE 305 and/or the Rx/Tx UE 310 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 3 is provided as an example. Other examples may differ from what is described with regard to FIG. 3.

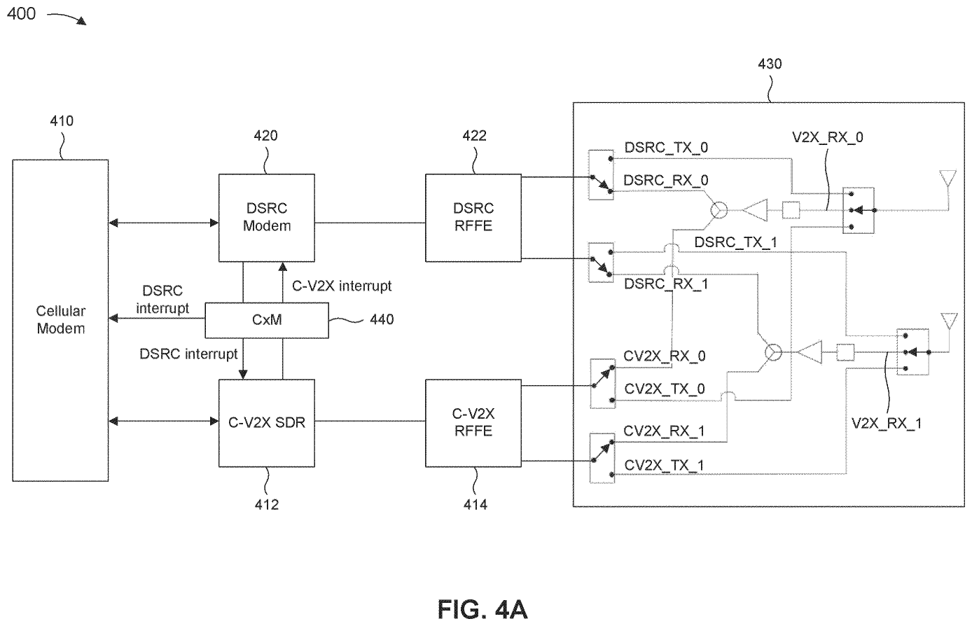

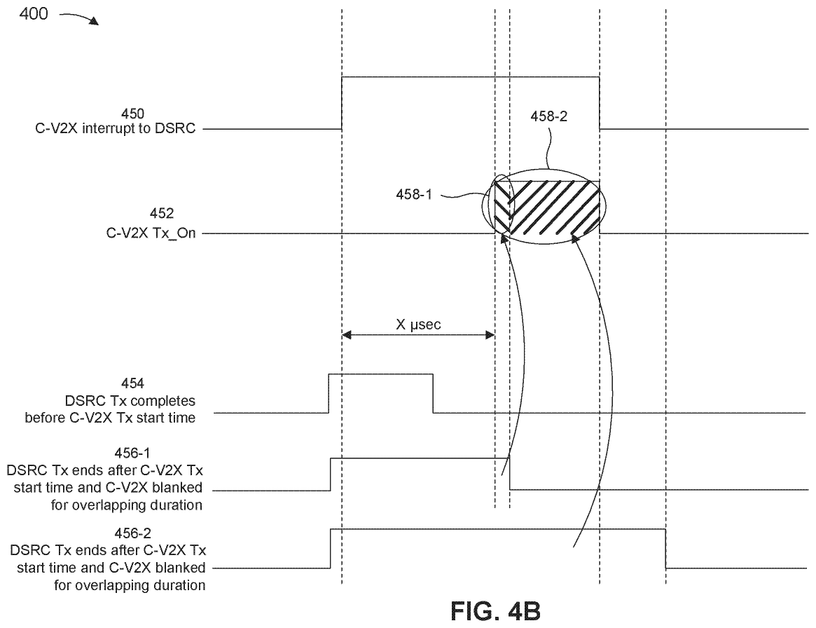

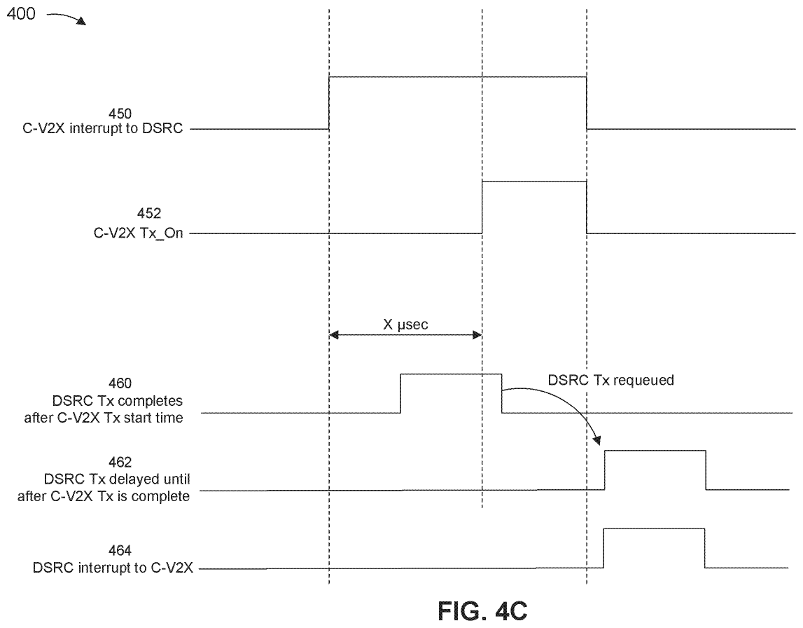

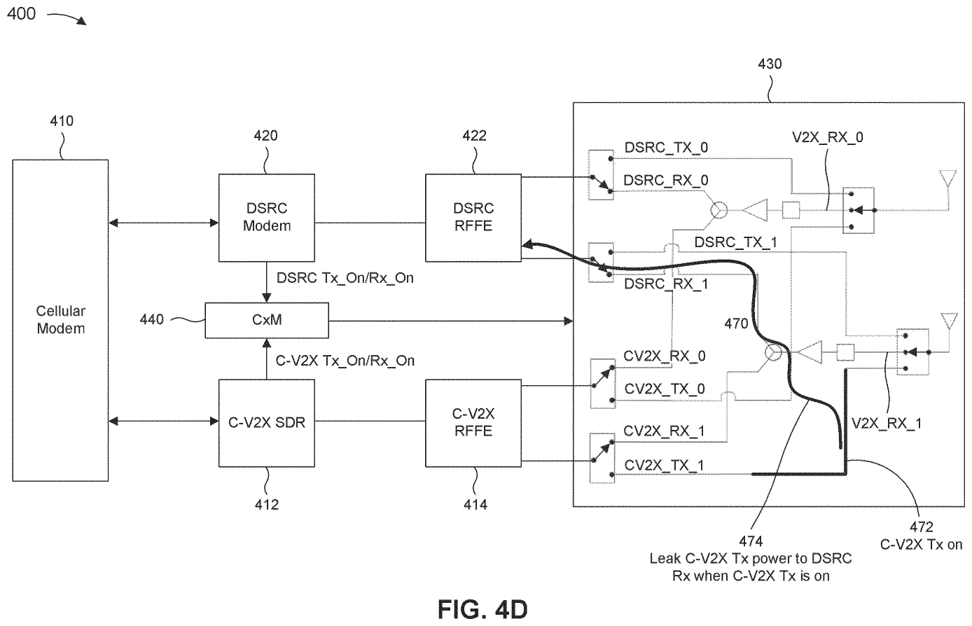

FIGS. 4A-4D are diagrams illustrating examples 400 associated with coexistence between different automotive RATs. FIG. 4A illustrates an example communication system that may be used in a vehicular UE to enable concurrent support for DSRC and C-V2X communication using interrupt-based techniques to transfer timing information to intelligently coordinate coexistence between DSRC and C-V2X components. FIG. 4B and FIG. 4C illustrate various scenarios in which a coexistence manager resolves potential collisions between a DSRC transmission and a C-V2X transmission. FIG. 4D illustrates an example communication system that may be used in a vehicular UE to enable concurrent support for DSRC and C-V2X by controlling power leakage on hardware leakage paths associated with different RATs.

In some cases, different automotive RATs such as DSRC and C-V2X may be deployed on different channels in an intelligent transport system (ITS) band. For example, DSRC is generally based on Institute of Electrical and Electronics Engineers (IEEE) 802.11p, which is an approved amendment to the IEEE 802.11 standard (e.g., DSRC is a Wi-Fi solution to support V2X communications, including data exchange between high-speed vehicles, or V2V communication, and between vehicles and roadside infrastructure, or V2I communication). On the other hand, C-V2X is an automotive RAT based on 3GPP standards, using mobile cellular connectivity based on an LTE RAT or an NR RAT to exchange messages between vehicles, pedestrians, wayside traffic control devices such as traffic signals, and wireless network infrastructure (e.g., one or more CUs, DUs, or RUs). In some areas (e.g., Europe and Japan), there are a significant number of vehicles that are already deployed with support for DSRC. However, because DSRC has not gained widespread adoption (e.g., due in part to the high cost and lack of interoperability with existing cellular networks), C-V2X has emerged as a more promising automotive RAT for enabling V2X applications worldwide.

Nonetheless, because many vehicles have already been deployed with support for DSRC, a V2X communication system (e.g., a V2X transceiver) may need to support different automotive RATs concurrently for both transmission and reception (e.g., a V2X communication system on a new vehicle may support DSRC to communicate with older vehicles that only support DSRC and may support C-V2X to communicate with newer vehicles, pedestrian devices, RSUs, and/or network infrastructure that are based on C-V2X standards). However, enabling concurrent support for DSRC and C-V2X poses various challenges. For example, a V2X communication system typically includes two antennas that are shared for transmission and reception using different automotive RATs, such as DSRC and C-V2X. This may be due, for example, to the high cost of cabling on the vehicular platform and/or to poor isolation between the antennas. In some cases, the half-duplex nature of V2X technology may be due to the restriction of the shared antennas for transmission and reception in V2X. For example, once there is a transmission using any of the automotive RATs from any one of the antennas, there may be no reception for any of the automotive RATs on all of the antennas. Furthermore, only one automotive RAT may be active at any given time (e.g., the two antennas are both used for DSRC or both used for C-V2X at any given time), and the different automotive RATs may be associated with slot structures that are not time aligned. Furthermore, different automotive RATs may use different communication technologies (e.g., OFDM with carrier-sense multiple access (CSMA) for DSRC 802.11p versus single-carrier frequency division multiplexing (SC-FDM) with semi-persistent sensing for C-V2X), may have different transmission times (e.g., typically 0.4 milliseconds (ms) for DSRC versus 1 ms for C-V2X), and/or may have different symbol durations (e.g., 8 microseconds (μs) for DSRC versus 71 μs for C-V2X). Accordingly, because there could be Tx-Tx collisions and/or Rx-Tx collisions between DSRC and C-V2X, a V2X communication system that concurrently supports DSRC and C-V2X may need to employ coexistence algorithms to resolve potential collisions.

For example, FIG. 4A illustrates an example communication system that may be used in a vehicular UE to enable concurrent support for DSRC and C-V2X. As shown in FIG. 4A, the communication system may support DSRC and C-V2X on different modems, which creates a need to manage coexistence between different chips that support different automotive RATs. For example, as shown in FIG. 4A, the communication system may include a cellular modem 410, a C-V2X software-defined radio (SDR) 412 (e.g., a C-V2X radio frequency (RF) transceiver), and a C-V2X RF front-end (RFFE), which may be provided on a first chip. As further shown, the communication system may include a DSRC modem 420 and a DSRC RFFE 422, which may be provided on a second chip. Accordingly, the communication system may include a switching subsystem 430 to pass transmit and/or receive signals between the two shared antennas and the C-V2X and DSRC components. For example, because DSRC and C-V2X are supported on different independent modems, the switching subsystem 430 may include various switches that are controlled by control signals coming from the C-V2X and DSRC components (e.g., a C-V2X Tx_On signal may be asserted, or go high, when there is an ongoing C-V2X transmission, a DSRC Tx_On signal may be asserted, or go high, when there is an ongoing DSRC transmission, and the front-end switching logic in the switching subsystem 430 may be derived from the C-V2X Tx On and DSRC Tx_On signals). However, in some cases, there may be conflict between the two automotive RATs, which have different timing structures. For example, DSRC and C-V2X have different transmit timings and different Rx timings, which could potentially result in Tx-Tx and/or Rx-Rx collisions.

Accordingly, in some aspects, the communication system may include a coexistence manager 440 (e.g., the coexistence manager 140) that may enable coexistence between the DSRC and C-V2X components that share one or more antennas. In some aspects, the coexistence manager 440 may be partially located on the first chip that includes the cellular modem 410, the C-V2X SDR 412, and the C-V2X RFFE 414 and partially located on the second chip that includes the DSRC modem 420 and the DSRC RFFE 422. However, it will be appreciated that other suitable configurations are possible for the coexistence manager 440. For example, in some aspects, the coexistence manager 440 may be located only on the first chip that includes the cellular modem 410, the C-V2X SDR 412, and the C-V2X RFFE 414, located only on the second chip that includes the DSRC modem 420 and the DSRC RFFE 422, or provided on a separate chip.

As shown in FIGS. 4A-4C and described in further detail herein, the coexistence manager 440 may be configured to monitor interrupts from the C-V2X SDR 412 and the DSRC modem 420 that indicate respective timings for C-V2X and DSRC transmissions. For example, the coexistence manager 440 may be configured to monitor a C-V2X interrupt that indicates timing information associated with the C-V2X Tx_On signal and a DSRC interrupt that indicates timing information associated with the DSRC Tx_On signal. Accordingly, in cases where there is a potential Tx-Tx collision (e.g., a DSRC transmission at least partially overlaps with a C-V2X transmission) or a potential Rx-Tx collision (e.g., a DSRC transmission at least partially overlaps with a C-V2X reception, or vice versa), the coexistence manager 440 may intelligently resolve the collision based on the DSRC and C-V2X timing information.

For example, as shown in FIG. 4A, the coexistence manager 440 may generally include an interface to receive a DSRC interrupt from the DSRC modem 420 and to receive a C-V2X interrupt from the C-V2X SDR 412, where the DSRC interrupt may indicate timing information associated with a DSRC transmission and the C-V2X interrupt may indicate timing information associated with a C-V2X transmission. Accordingly, the coexistence manager 440 may generally use the timing information conveyed by the DSRC interrupt to transfer DSRC timing information to the C-V2X components (e.g., the cellular modem 410 and the C-V2X SDR 412) and may use the timing information conveyed by the C-V2X interrupt to transfer C-V2X timing information to the DSRC components (e.g., the DSRC modem 420). For example, in some aspects, the interface may include general-purpose input/output (GPIO) or general radio frequency connection (GRFC) lines provided between the DSRC and C-V2X components to convey timing information between the DSRC and C-V2X components at runtime. Alternatively, in some aspects, the coexistence manager 440 may share timing information between the DSRC and C-V2X components using a two-wire interface, and the coexistence manager 440 may make a centralized decision to select or schedule DSRC and/or C-V2X transmissions to prevent collisions in time.

For example, FIG. 4B and FIG. 4C illustrate various scenarios in which the coexistence manager 440 may perform one or more actions to resolve a potential collision between a DSRC transmission and a C-V2X transmission. For example, in some aspects, timing information associated with a C-V2X transmission may generally be available at the cellular modem 410 and the C-V2X SDR 412 a certain amount of time (e.g., X microseconds (μs)) prior to a time when the actual C-V2X transmission is scheduled to begin. Accordingly, in some aspects, the C-V2X SDR 412 may send an interrupt to the coexistence manager 440 that indicates timing information associated with an upcoming C-V2X transmission X μs prior to the time when the C-V2X transmission is scheduled to begin. For example, referring to FIG. 4B and FIG. 4C, reference number 450 depicts a waveform associated with the interrupt that the coexistence manager 440 receives from the C-V2X SDR 412 to indicate timing information associated with an upcoming C-V2X transmission (e.g., a C-V2X interrupt to DSRC, which may also be referred to as a DSRC interrupt from C-V2X), and reference number 452 depicts a waveform associated with the C-V2X Tx_On signal that is asserted during a C-V2X transmission. As shown, the C-V2X interrupt indicating the timing information of the upcoming C-V2X transmission is asserted X μs prior to the time when the C-V2X transmission is scheduled to begin, and the C-V2X interrupt is unasserted (e.g., goes low) when the C-V2X transmission is complete. Accordingly, the coexistence manager 440 may perform one or more actions to manage coexistence between the DSRC and C-V2X components in cases where there is an ongoing DSRC transmission when the coexistence manager 440 receives the interrupt indicating the timing information of the upcoming C-V2X transmission and/or a DSRC transmission needs to start after the coexistence manager 440 receives the interrupt indicating the timing information of the upcoming C-V2X transmission.

For example, FIG. 4B depicts various scenarios where there is an ongoing DSRC transmission at the time when the coexistence manager 440 receives the C-V2X interrupt indicating the timing information of the upcoming C-V2X transmission. For example, reference numbers 454, 456-1, and 456-2 each depict an example state of a DSRC Tx_On signal that is asserted when the C-V2X interrupt is received to indicate the timing information of the upcoming C-V2X transmission, which indicates that there is an ongoing DSRC transmission when the C-V2X interrupt is received. In general, timing information associated with the ongoing DSRC transmission may be available to the coexistence manager 440 (e.g., by monitoring the timing of the DSRC transmission and/or monitoring any interrupts that the DSRC modem 420 sends to the C-V2X components via the coexistence manager 440). Accordingly, the coexistence manager 440 may use the timing information associated with the ongoing DSRC transmission and the timing information associated with the upcoming C-V2X transmission to resolve any potential collisions. For example, reference number 454 depicts an example where the ongoing DSRC transmission is scheduled to complete prior to the start time of the upcoming C-V2X transmission, in which case the action performed by the coexistence manager 440 may be to allow the ongoing DSRC transmission to continue based on a determination that the ongoing DSRC transmission will complete prior to the start time of the upcoming C-V2X transmission (e.g., if the remaining time of the ongoing DSRC transmission is less than X μs, the DSRC transmission may complete because the DSRC transmission will not collide with the C-V2X slot structure associated with the upcoming C-V2X transmission, which may proceed as-scheduled after the DSRC transmission is complete).

However, in cases where the remaining time of the ongoing DSRC transmission equals or exceeds X μs, the ongoing DSRC transmission will at least partially overlap with and therefore collide with the upcoming C-V2X transmission. In such cases, the coexistence manager 440 may need to perform one or more actions to manage coexistence between the colliding DSRC and C-V2X transmissions. For example, in some cases, the coexistence manager 440 may drop the DSRC transmission (e.g., by signaling or otherwise controlling the DSRC modem 420 to discontinue, delay, or requeue the DSRC transmission for a given duration) responsive to a determination that the DSRC transmission has a completion time that is later than the start time of the upcoming C-V2X transmission (e.g., the DSRC transmission will enter the slot structure associated with the upcoming C-V2X transmission). Alternatively, in some aspects, the coexistence manager 440 may allow the ongoing DSRC transmission to continue and may suppress the C-V2X transmission during a time period when the ongoing DSRC transmission overlaps with the C-V2X transmission. For example, reference number 456-1 depicts a first scenario where the ongoing DSRC transmission partially overlaps with the upcoming C-V2X transmission (e.g., the ongoing DSRC transmission will complete after the start time of the upcoming C-V2X transmission, but before the completion time of the upcoming C-V2X transmission). In such cases, as shown by reference number 458-1, the coexistence manager 440 may suppress (e.g., blank) the C-V2X transmission only during a time period when the ongoing DSRC transmission overlaps with the C-V2X transmission, and the C-V2X transmission may be allowed to start after the DSRC transmission is complete. In another example, reference number 456-2 depicts a second scenario where the ongoing DSRC transmission completely overlaps with the upcoming C-V2X transmission (e.g., the ongoing DSRC transmission will complete after the scheduled completion time of the upcoming C-V2X transmission). In such cases, as shown by reference number 458-2, the coexistence manager 440 may suppress the entire C-V2X transmission. In some aspects, in order to suppress any portion of the C-V2X transmission, the coexistence manager 440 may use digital-to-analog converter (DAC) blanking circuitry to blank all the DAC inputs in the C-V2X SDR 412 during the time period when the ongoing DSRC transmission overlaps with the C-V2X transmission. For example, the coexistence manager 440 may suppress the C-V2X transmission (e.g., blank the DAC inputs of the C-V2X SDR 412) while the DSRC interrupt that the DSRC modem 420 sends to the C-V2X components is asserted. Additionally, or alternatively, FIG. 4C depicts various scenarios where a DSRC transmission needs to start after the coexistence manager 440 receives the C-V2X interrupt indicating the timing information of the upcoming C-V2X transmission. As described herein, the coexistence manager 440 may perform an action to manage coexistence between the DSRC transmission and the upcoming C-V2X transmission based on a duration of the DSRC transmission and/or a priority associated with the DSRC transmission. For example, in cases where the DSRC transmission can complete before the scheduled start time of the upcoming C-V2X transmission, the coexistence manager 440 may allow the DSRC transmission to complete. However, in cases where the DSRC transmission will not complete until after the scheduled start time of the upcoming C-V2X transmission, the coexistence manager 440 may need to delay or suppress one of the colliding transmissions. For example, referring to FIG. 4C, reference number 460 depicts a scenario where the DSRC transmission will not complete until after the scheduled start time of the upcoming C-V2X transmission. Accordingly, as shown by reference number 462, the DSRC transmission may be delayed until after the C-V2X transmission is complete. Further, reference number 464 indicates a state of the DSRC interrupt that the DSRC modem 420 sends to the C-V2X components via the coexistence manager 440 when the DSRC transmission is being performed. For example, the DSRC transmission may be requeued for a time after the C-V2X transmission is complete, and DSRC receive operations may continue while the DSRC transmission is delayed such that the DSRC modem 420 may continue to obtain clear channel assessment (CCA) measurements while the DSRC transmission is delayed. Accordingly, the DSRC modem 420 may then decide whether to perform the DSRC transmission at the time when the DSRC transmission is requeued based on the CCA measurements that were obtained while the DSRC transmission was delayed.

In general, when the DSRC transmission is delayed, the coexistence manager 440 may determine the duration to delay the DSRC transmission based on the packet contents of the DSRC transmission, which may be useful in cases where the C-V2X components need to transmit in multiple consecutive slots. For example, a DSRC transmission with a low priority may be delayed for a longer duration to allow the C-V2X transmissions over multiple consecutive slots. Additionally, or alternatively, in cases where the DSRC transmission has a high priority (e.g., the DSRC transmission is carrying an acknowledgement or other message that has to be sent immediately), the coexistence manager 440 may perform the DSRC transmission and suppress the C-V2X transmission during any time period in which the DSRC transmission overlaps with the C-V2X transmission (e.g., by blanking the DAC inputs of the C-V2X SDR 412). In such cases, the C-V2X interrupt to the DSRC modem 420 and the DSRC interrupt to the C-V2X components will both be high, and the C-V2X transmission may be suppressed while the C-V2X interrupt to the DSRC modem 420 and the DSRC interrupt to the C-V2X components are both high (e.g., the overlapping duration).

In some aspects, in addition to or instead of managing coexistence based on the interrupts that indicate the timing information for DSRC and C-V2X transmissions, the coexistence manager 440 may suppress or delay a DSRC transmission by leaking transmit power from a C-V2X transmit path into a DSRC receive path. For example, referring to FIG. 4D, the communication system that supports DSRC and C-V2X may include a hardware leakage path 470 from a C-V2X transmit path into a DSRC receive path. In this case, the coexistence manager 440 may monitor respective transmit power levels on the DSRC and C-V2X transmit paths and may control power leakage on the hardware leakage path 470 from the C-V2X transmit path to the DSRC receive path in accordance with the respective transmit power levels. For example, when the respective transmit power levels indicate that the C-V2X components are transmitting and that the DSRC components are in a receive mode, the coexistence manager 440 may leak transmit power from the C-V2X transmit path to the DSRC receive path to delay or suppress any DSRC transmission that may need to start while the C-V2X transmission is ongoing. Additionally, or alternatively, as shown in FIG. 4D, the coexistence manager 440 may monitor a DSRC Tx_On signal, a DSRC Rx_On signal, a C-V2X Tx_On signal, and/or a C-V2X Rx_On signal to determine the current state of the C-V2X and DSRC components at any given time. In either case, as shown by reference numbers 472 and 474, the coexistence manager 440 may determine when a C-V2X transmission is ongoing and may leak transmit power from the C-V2X transmit path to the DSRC receive path until the transmit power level and/or C-V2X Tx_On or C-V2X Rx On signals indicate that the C-V2X components are no longer transmitting. For example, the coexistence manager 440 may leak sufficient transmit power from the C-V2X transmit path to the DSRC receive path to satisfy (e.g., exceed) a threshold associated with a busy state for a DSRC wireless channel (e.g., to ensure that CCA measurements will indicate a busy state such that the DSRC modem 420 delays any DSRC transmission that arises while the C-V2X transmission is ongoing). Furthermore, in some aspects, the coexistence manager 440 may dynamically adjust an attenuation level on the hardware leakage path 470 to ensure that the transmit power leaked to the DSRC receive path is sufficient to satisfy the threshold associated with a busy state for a DSRC wireless channel. For example, in some cases (e.g., a low-power C-V2X transmission), the transmit power leaked from the C-V2X transmit path to the DSRC receive path may be lower than the threshold, whereby the coexistence manager 440 may adjust the attenuation level on the hardware leakage path 470 based on the transmit power level on the C-V2X transmit path.

As indicated above, FIGS. 4A-4D are provided as an example. Other examples may differ from what is described with regard to FIGS. 4A-4D. For example, although not shown in FIG. 4A or FIG. 4D, the cellular modem 410 may be coupled to a wide area network (WAN) SDR, which may provide a cellular RFFE associated with an antenna subsystem separate from the two antennas used by the C-V2X and DSRC components.

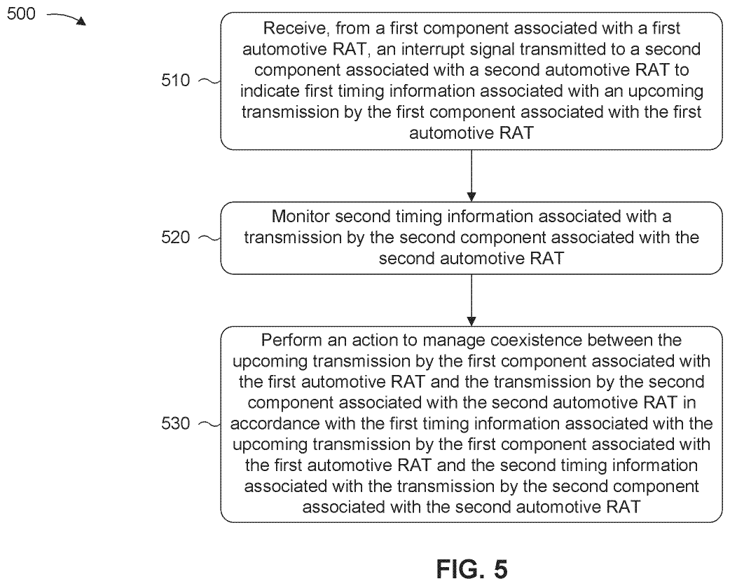

FIG. 5 is a diagram illustrating an example process 500 associated with coexistence between different automotive RATS. Example process 500 is an example where a UE (e.g., UE 120) or a component of a UE (e.g., coexistence manager 140 and/or coexistence manager 440) performs operations associated with managing coexistence between different automotive RATs.

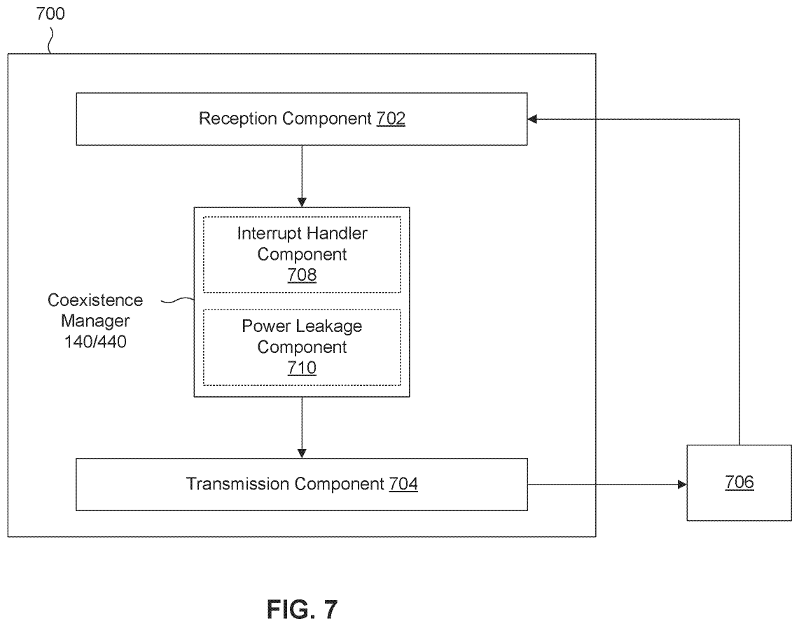

As shown in FIG. 5, in some aspects, process 500 may include receiving, from a first component associated with a first automotive RAT (e.g., the C-V2X SDR 412 shown in FIG. 4), an interrupt signal transmitted to a second component associated with a second automotive RAT (e.g., the DSRC modem 420 shown in FIG. 4) to indicate first timing information associated with an upcoming transmission by the first component associated with the first automotive RAT (block 510). For example, the UE (e.g., using coexistence manager 140/440 and/or interrupt handler component 708, depicted in FIG. 7) may receive, from a first component associated with a first automotive RAT, an interrupt signal transmitted to a second component associated with a second automotive RAT to indicate first timing information associated with an upcoming transmission by the first component associated with the first automotive RAT, as described above.

As further shown in FIG. 5, in some aspects, process 500 may include monitoring second timing information associated with a transmission by the second component associated with the second automotive RAT (block 520). For example, the UE (e.g., using coexistence manager 140/440 and/or interrupt handler component 708, depicted in FIG. 7) may monitor second timing information associated with a transmission by the second component associated with the second automotive RAT, as described above.

As further shown in FIG. 5, in some aspects, process 500 may include performing an action to manage coexistence between the upcoming transmission by the first component associated with the first automotive RAT and the transmission by the second component associated with the second automotive RAT in accordance with the first timing information associated with the upcoming transmission by the first component associated with the first automotive RAT and the second timing information associated with the transmission by the second component associated with the second automotive RAT (block 530). For example, the UE (e.g., using coexistence manager 140/150 and/or interrupt handler component 708, depicted in FIG. 7) may perform an action to manage coexistence between the upcoming transmission by the first component associated with the first automotive RAT and the transmission by the second component associated with the second automotive RAT in accordance with the first timing information associated with the upcoming transmission by the first component associated with the first automotive RAT and the second timing information associated with the transmission by the second component associated with the second automotive RAT, as described above.

Process 500 may include additional aspects, such as any single aspect or any combination of aspects described below and/or in connection with one or more other processes described elsewhere herein.

In a first aspect, the transmission by the second component is ongoing when the interrupt signal is sent to the second component.

In a second aspect, alone or in combination with the first aspect, the action is to allow completion of the transmission by the second component responsive to a determination that the transmission by the second component has a completion time that is earlier than a start time of the upcoming transmission by the first component.

In a third aspect, alone or in combination with one or more of the first and second aspects, the action is to drop the transmission by the second component responsive to a determination that the transmission by the second component has a completion time that is later than a start time of the upcoming transmission by the first component.

In a fourth aspect, alone or in combination with one or more of the first through third aspects, the action is to allow completion of the transmission by the second component and assert an interrupt to suppress the upcoming transmission by the first component during a time period when the transmission by the second component collides with the upcoming transmission by the first component.

In a fifth aspect, alone or in combination with one or more of the first through fourth aspects, the transmission by the second component is scheduled after the interrupt signal is received.

In a sixth aspect, alone or in combination with one or more of the first through fifth aspects, the action is to perform the transmission by the second component responsive to a determination that the transmission by the second component has a completion time that is earlier than a start time of the upcoming transmission by the first component.

In a seventh aspect, alone or in combination with one or more of the first through sixth aspects, the action is to delay the transmission by the second component until the upcoming transmission by the first component is complete.

In an eighth aspect, alone or in combination with one or more of the first through seventh aspects, the transmission by the second component is delayed by a duration that is associated with packet contents included in the transmission by the second component.

In a ninth aspect, alone or in combination with one or more of the first through eighth aspects, the action is to perform the transmission by the second component and assert an interrupt to suppress the upcoming transmission by the first component during a time period when the transmission by the second component collides with the upcoming transmission by the first component responsive to a priority of the transmission by the second component.

In a tenth aspect, alone or in combination with one or more of the first through ninth aspects, the interrupt signal is communicated over a GRFC interface between the first component and the second component.

In an eleventh aspect, alone or in combination with one or more of the first through tenth aspects, the interrupt signal is communicated over a GPIO interface between the first component and the second component.

In a twelfth aspect, alone or in combination with one or more of the first through eleventh aspects, the interrupt signal is communicated over a two-wire interface between the first component and the second component.

In a thirteenth aspect, alone or in combination with one or more of the first through twelfth aspects, the first component and the second component share one or more antennas.

In a fourteenth aspect, alone or in combination with one or more of the first through thirteenth aspects, the first automotive RAT is associated with C-V2X communications and the second automotive RAT is associated with DSRC.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

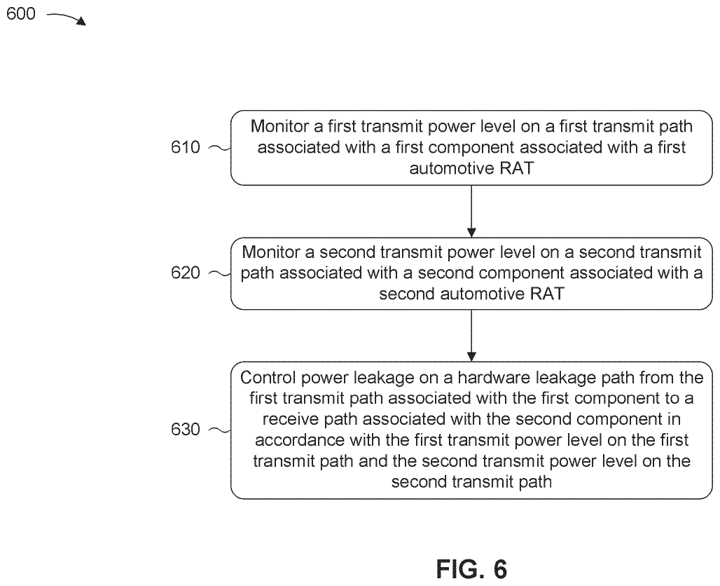

FIG. 6 is a diagram illustrating an example process 600 associated with coexistence between different automotive RATs. Example process 600 is an example where a UE (e.g., UE 120) or a component of a UE (e.g., coexistence manager 140 and/or coexistence manager 440) performs operations associated with coexistence between different automotive RATs.

As shown in FIG. 6, in some aspects, process 600 may include monitoring a first transmit power level on a first transmit path associated with a first component associated with a first automotive RAT (block 610). For example, the UE (e.g., using coexistence manager 140/440 and/or power leakage component 710, depicted in FIG. 7) may monitor a first transmit power level on a first transmit path associated with a first component associated with a first automotive RAT (e.g., the C-V2X SDR 412 shown in FIG. 4), as described above.

As further shown in FIG. 6, in some aspects, process 600 may include monitoring a second transmit power level on a second transmit path associated with a second component associated with a second automotive RAT (block 620). For example, the UE (e.g., using coexistence manager 140/440 and/or power leakage component 710, depicted in FIG. 7) may monitor a second transmit power level on a second transmit path associated with a second component associated with a second automotive RAT (e.g., the DSRC modem 420 shown in FIG. 4), as described above.

As further shown in FIG. 6, in some aspects, process 600 may include controlling power leakage on a hardware leakage path from the first transmit path associated with the first component to a receive path associated with the second component in accordance with the first transmit power level on the first transmit path and the second transmit power level on the second transmit path (block 630). For example, the UE (e.g., using coexistence manager 140/440 and/or power leakage component 710, depicted in FIG. 7) may control power leakage on a hardware leakage path from the first transmit path associated with the first component to a receive path associated with the second component in accordance with the first transmit power level on the first transmit path and the second transmit power level on the second transmit path, as described above.

Process 600 may include additional aspects, such as any single aspect or any combination of aspects described below and/or in connection with one or more other processes described elsewhere herein.

In a first aspect, controlling the power leakage on the hardware leakage path includes leaking power from the first transmit path associated with the first component into the receive path associated with the second component responsive to the first transmit power level indicating that the first component is transmitting and a determination that the second component is in a receive mode.

In a second aspect, alone or in combination with the first aspect, the power is leaked from the first transmit path associated with the first component into the receive path associated with the second component until the first transmit power level indicates that the first component is not transmitting.

In a third aspect, alone or in combination with one or more of the first and second aspects, the power leakage on the hardware leakage path satisfies a threshold associated with a busy state for a wireless channel associated with the second automotive RAT.

In a fourth aspect, alone or in combination with one or more of the first through third aspects, controlling the power leakage on the hardware leakage path includes adjusting an attenuation level on the hardware leakage path in accordance with the first transmit power level to ensure that the power leakage on the hardware leakage path satisfies the threshold.

In a fifth aspect, alone or in combination with one or more of the first through fourth aspects, the first component and the second component share one or more antennas.

In a sixth aspect, alone or in combination with one or more of the first through fifth aspects, the first automotive RAT is associated with C-V2X communications and the second automotive RAT is associated with DSRC.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for managing coexistence between different automotive RATs. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the coexistence manager 140 and/or 440, shown in FIG. 7 and described herein as coexistence manager 140/440. The communication manager 140/440 may include one or more of an interrupt handler component 708 or a power leakage component 710, among other examples.

In some aspects, the apparatus 700 may be configured to perform one or more operations described herein in connection with FIGS. 4A-4C and/or FIG. 5. Additionally, or alternatively, the apparatus 700 may be configured to perform one or more processes described herein, such as process 500 of FIG. 5, process 600 of FIG. 6, or a combination thereof. In some aspects, the apparatus 700 and/or one or more components shown in FIG. 7 may include one or more components of the UE described in connection with FIGS. 4A-4D. Additionally, or alternatively, one or more components shown in FIG. 7 may be implemented within one or more components described in connection with FIGS. 4A-4D. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The interrupt handler component 708 may receive, from a first component associated with a first automotive RAT, an interrupt signal transmitted to a second component associated with a second automotive RAT to indicate first timing information associated with an upcoming transmission by the first component associated with the first automotive RAT. The interrupt handler component 708 may monitor second timing information associated with a transmission by the second component associated with the second automotive RAT. The interrupt handler component 708 may perform an action to manage coexistence between the upcoming transmission by the first component associated with the first automotive RAT and the transmission by the second component associated with the second automotive RAT in accordance with the first timing information associated with the upcoming transmission by the first component associated with the first automotive RAT and the second timing information associated with the transmission by the second component associated with the second automotive RAT.

The power leakage component 710 may monitor a first transmit power level on a first transmit path associated with a first component associated with a first automotive RAT. The power leakage component 710 may monitor a second transmit power level on a second transmit path associated with a second component associated with a second automotive RAT. The power leakage component 710 may control power leakage on a hardware leakage path from the first transmit path associated with the first component to a receive path associated with the second component in accordance with the first transmit power level on the first transmit path and the second transmit power level on the second transmit path.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:
Aspect 1: A method of managing wireless communication in a vehicular communication system performed by a UE, comprising: receiving, from a first component associated with a first automotive RAT, an interrupt signal transmitted to a second component associated with a second automotive RAT to indicate first timing information associated with an upcoming transmission by the first component associated with the first automotive RAT; monitoring second timing information associated with a transmission by the second component associated with the second automotive RAT; and performing an action to manage coexistence between the upcoming transmission by the first component associated with the first automotive RAT and the transmission by the second component associated with the second automotive RAT in accordance with the first timing information associated with the upcoming transmission by the first component associated with the first automotive RAT and the second timing information associated with the transmission by the second component associated with the second automotive RAT.
Aspect 2: The method of Aspect 1, wherein the transmission by the second component is ongoing when the interrupt signal is sent to the second component.
Aspect 3: The method of Aspect 2, wherein the action is to allow completion of the transmission by the second component responsive to a determination that the transmission by the second component has a completion time that is earlier than a start time of the upcoming transmission by the first component.
Aspect 4: The method of Aspect 2, wherein the action is to drop the transmission by the second component responsive to a determination that the transmission by the second component has a completion time that is later than a start time of the upcoming transmission by the first component.
Aspect 5: The method of Aspect 2, wherein the action is to allow completion of the transmission by the second component and assert an interrupt to suppress the upcoming transmission by the first component during a time period when the transmission by the second component collides with the upcoming transmission by the first component.
Aspect 6: The method of Aspect 1, wherein the transmission by the second component is scheduled after the interrupt signal is received.
Aspect 7: The method of Aspect 6, wherein the action is to perform the transmission by the second component responsive to a determination that the transmission by the second component has a completion time that is earlier than a start time of the upcoming transmission by the first component.
Aspect 8: The method of Aspect 6, wherein the action is to delay the transmission by the second component until the upcoming transmission by the first component is complete.
Aspect 9: The method of Aspect 8, wherein the transmission by the second component is delayed by a duration that is associated with packet contents included in the transmission by the second component.
Aspect 10: The method of Aspect 6, wherein the action is to perform the transmission by the second component and assert an interrupt to suppress the upcoming transmission by the first component during a time period when the transmission by the second component collides with the upcoming transmission by the first component responsive to a priority of the transmission by the second component.
Aspect 11: The method of any of Aspects 1-10, wherein the interrupt signal is communicated over a GRFC interface between the first component and the second component.
Aspect 12: The method of any of Aspects 1-11, wherein the interrupt signal is communicated over a GPIO interface between the first component and the second component.
Aspect 13: The method of any of Aspects 1-12, wherein the interrupt signal is communicated over a two-wire interface between the first component and the second component.
Aspect 14: The method of any of Aspects 1-13, wherein the first component and the second component share one or more antennas.
Aspect 15: The method of any of Aspects 1-14, wherein the first automotive RAT is associated with C-V2X communications and the second automotive RAT is associated with DSRC.
Aspect 16: A method of managing wireless communication in a vehicular communication system performed by a UE, comprising: monitoring a first transmit power level on a first transmit path associated with a first component associated with a first automotive RAT; monitoring a second transmit power level on a second transmit path associated with a second component associated with a second automotive RAT; and controlling power leakage on a hardware leakage path from the first transmit path associated with the first component to a receive path associated with the second component in accordance with the first transmit power level on the first transmit path and the second transmit power level on the second transmit path.
Aspect 17: The method of Aspect 16, wherein controlling the power leakage on the hardware leakage path includes leaking power from the first transmit path associated with the first component into the receive path associated with the second component responsive to the first transmit power level indicating that the first component is transmitting and a determination that the second component is in a receive mode.
Aspect 18: The method of Aspect 17, wherein the power is leaked from the first transmit path associated with the first component into the receive path associated with the second component until the first transmit power level indicates that the first component is not transmitting.
Aspect 19: The method of any of Aspects 17-18, wherein the power leakage on the hardware leakage path satisfies a threshold associated with a busy state for a wireless channel associated with the second automotive RAT.
Aspect 20: The method of Aspect 19, wherein controlling the power leakage on the hardware leakage path includes adjusting an attenuation level on the hardware leakage path in accordance with the first transmit power level to ensure that the power leakage on the hardware leakage path satisfies the threshold.
Aspect 21: The method of any of Aspects 16-20, wherein the first component and the second component share one or more antennas.
Aspect 22: The method of any of Aspects 16-21, wherein the first automotive RAT is associated with C-V2X communications and the second automotive RAT is associated with DSRC.
Aspect 23: An apparatus for wireless communication at a device, comprising a processor; memory coupled with the processor; and instructions stored in the memory and executable by the processor to cause the apparatus to perform the method of one or more of Aspects 1-22.
Aspect 24: A device for wireless communication, comprising a memory and one or more processors coupled to the memory, the one or more processors configured to perform the method of one or more of Aspects 1-22.
Aspect 25: An apparatus for wireless communication, comprising at least one means for performing the method of one or more of Aspects 1-22.
Aspect 26: A non-transitory computer-readable medium storing code for wireless communication, the code comprising instructions executable by a processor to perform the method of one or more of Aspects 1-22.
Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A coexistence manager for managing wireless communication in a vehicular communication system, comprising:
a memory; and
one or more processors, operatively coupled to the memory, configured to:
receive, from a first component associated with a first automotive radio access technology (RAT), an interrupt signal transmitted to a second component associated with a second automotive RAT to indicate first timing information associated with an upcoming transmission by the first component associated with the first automotive RAT;
monitor second timing information associated with a transmission by the second component associated with the second automotive RAT; and
perform an action to manage coexistence between the upcoming transmission by the first component associated with the first automotive RAT and the transmission by the second component associated with the second automotive RAT in accordance with the first timing information associated with the upcoming transmission by the first component associated with the first automotive RAT and the second timing information associated with the transmission by the second component associated with the second automotive RAT.

2. The coexistence manager of claim 0, wherein the transmission by the second component is ongoing when the interrupt signal is sent to the second component.

3. The coexistence manager of claim 0, wherein the action is to allow completion of the transmission by the second component responsive to a determination that the transmission by the second component has a completion time that is earlier than a start time of the upcoming transmission by the first component.

4. The coexistence manager of claim 0, wherein the action is to drop the transmission by the second component responsive to a determination that the transmission by the second component has a completion time that is later than a start time of the upcoming transmission by the first component.

5. The coexistence manager of claim 0, wherein the action is to allow completion of the transmission by the second component and assert an interrupt to suppress the upcoming transmission by the first component during a time period when the transmission by the second component collides with the upcoming transmission by the first component.

6. The coexistence manager of claim 0, wherein the transmission by the second component is scheduled after the interrupt signal is received.

7. The coexistence manager of claim 0, wherein the action is to perform the transmission by the second component responsive to a determination that the transmission by the second component has a completion time that is earlier than a start time of the upcoming transmission by the first component.

8. The coexistence manager of claim 0, wherein the action is to delay the transmission by the second component until the upcoming transmission by the first component is complete.

9. The coexistence manager of claim 0, wherein the transmission by the second component is delayed by a duration that is associated with packet contents included in the transmission by the second component.

10. The coexistence manager of claim 0, wherein the action is to perform the transmission by the second component and assert an interrupt to suppress the upcoming transmission by the first component during a time period when the transmission by the second component collides with the upcoming transmission by the first component responsive to a priority of the transmission by the second component.

11. The coexistence manager of claim 0, wherein the interrupt signal is communicated over at least one of a general radio frequency connection (GRFC) interface, a general purpose input/output (GPIO) interface, or a two-wire interface between the first component and the second component.

12-13. (canceled)

14. The coexistence manager of claim 0, wherein the first component and the second component share one or more antennas.

15. The coexistence manager of claim 0, wherein the first automotive RAT is associated with cellular vehicle-to-everything (V2X) communications and the second automotive RAT is associated with dedicated short-range communications (DSRC).

16. A coexistence manager for managing wireless communication in a vehicular communication system, comprising:
a memory; and
one or more processors, operatively coupled to the memory, configured to:
monitor a first transmit power level on a first transmit path associated with a first component associated with a first automotive radio access technology (RAT);
monitor a second transmit power level on a second transmit path associated with a second component associated with a second automotive RAT; and
control power leakage on a hardware leakage path from the first transmit path associated with the first component to a receive path associated with the second component in accordance with the first transmit power level on the first transmit path and the second transmit power level on the second transmit path.

17. The coexistence manager of claim 0, wherein the one or more processors, to control the power leakage on the hardware leakage path, are configured to leak power from the first transmit path associated with the first component into the receive path associated with the second component responsive to the first transmit power level indicating that the first component is transmitting and a determination that the second component is in a receive mode.

18. The coexistence manager of claim 0, wherein the power is leaked from the first transmit path associated with the first component into the receive path associated with the second component until the first transmit power level indicates that the first component is not transmitting.

19. The coexistence manager of claim 0, wherein the power leakage on the hardware leakage path satisfies a threshold associated with a busy state for a wireless channel associated with the second automotive RAT.

20. The coexistence manager of claim 0, wherein the one or more processors, to control the power leakage on the hardware leakage path, are configured to adjust an attenuation level on the hardware leakage path in accordance with the first transmit power level to ensure that the power leakage on the hardware leakage path satisfies the threshold.

21. (canceled)

22. The coexistence manager of claim 0, wherein the first automotive RAT is associated with cellular vehicle-to-everything (V2X) communications and the second automotive RAT is associated with dedicated short-range communications (DSRC).

23. A method of managing wireless communication in a vehicular communication system performed by a user equipment (UE), comprising:
receiving, from a first component associated with a first automotive radio access technology (RAT), an interrupt signal transmitted to a second component associated with a second automotive RAT to indicate first timing information associated with an upcoming transmission by the first component associated with the first automotive RAT;
monitoring second timing information associated with a transmission by the second component associated with the second automotive RAT; and
performing an action to manage coexistence between the upcoming transmission by the first component associated with the first automotive RAT and the transmission by the second component associated with the second automotive RAT in accordance with the first timing information associated with the upcoming transmission by the first component associated with the first automotive RAT and the second timing information associated with the transmission by the second component associated with the second automotive RAT.

24-48. (canceled)
